(19) United States
(12) Patent Application Publication
(10) Pub. No.: US 2021/0224136 A1
(43) Pub. Date: Jul. 22, 2021

(54) System Used by CDN Companies to Improve the Quality Offered to the Users and to Optimize Resource Utilization

(71) Applicant: Medianova internet Hizmetleri Ve Ticaret Anonim Sirketi, Sisli/lstanbul (TR)

(72) Inventors: Serkan SEVIM, Istanbul (TR); Elif AK, Istanbul (TR); Berk CANBERK, Istanbul (TR)

(73) Assignee: Medianova Internet Hizmetleri Ve Ticaret Anonirn Sirketi, Sisli/istanbul (TR)

(21) Appl. No.: 17/265,523

(22) PCT Filed: Oct. 17, 2018
(86) PCT No.: PCT/TR2018/050599

§ 371 Date: Feb. 3, 2021

(30) Foreign Application Priority Data
Aug. 3, 2018 (TR) 2018/11297

(51) Int. Cl. G06F 9/50; G06F 9/455

(52) U.S. Cl. CPC G06F 9/5083; G06F 2009/45595; G06F 9/5077; G06F 9/45558

(57) ABSTRACT

The invention relates to the system used by CDN companies to 5 improve the quality offered to the users and to optimize resource utilization characterized as containing the following process steps: the workload automation engine (60) should be listening the instance manager (70) (S2001), the Instance Manager (70) sends the source information of the physical machine (30) to the Workload Automation Engine (60) at the 10 end of the period (S2002), number of incoming requests are sent by the load balancer (50) to the workload automation engine (60) based on the request type (S2003), the VNF (40) distribution is created by the workload automation (60) according to the new algorithm (S2004), checking whether the newly generated VNF (40) distribution is different from the 15 previous period distribution (S2005), the new VNF (40) distribution is sent by the workload automation engine (60) to the instance managers (70) (S2006), the processes to be performed with respect to each of the CDN nodes (41, 42, 43) in their own physical machines (30) are compared by from the instance managers (70) according to the decision received from 20 the workload automation engine (60) (S2007) and observations of the requests up to the end of another period and the monitoring of the source states of the physical machines (30) (S2008).

### TECHNICAL FIELD

The invention is used by CDN (Content Delivery Network) companies to improve the quality offered to the users and to optimize resource utilization. CDN is a cloud computing service that allows users to quickly access data requested by users (large shopping sites, news sites, multimedia sharing platforms, etc.) over PoPs (Point of Presences) located at various points around the world. The invention basically consists of modules and algorithms that orchestrate (route) resource utilization by managing VNFs (Virtual Network Functions) and evaluating information periodically from these VNFs.

### PRIOR ART

CDN (content delivery network) provides CDN support by focusing on service in 4 different ways according to users' requests. These services include; small size data (ex: picture), large size data (ex: pictures. Pdf or JavaScript/css files) and streaming requests such as live broadcast or online video. Since these different user requests have to fulfilled with different types of servers, existing CDN structures configure a separate physical machine for each network function. This causes the resources of some physical machines to be idle when low number of requests comes from users. For example, in some hours of the day, the number of requests for live streaming is too high, while the number of requests for image content is low. In this case, while the CDN server responding to the image requests uses the resources at the minimum level, the server that responds to the video requests needs additional resource support in order not to reduce service quality. In the known art, functions (1000) performed by the main system used in the CDN companies are are carried our according to following process steps,
Creation of a request to the web page requested by the user (S1001),
Arrival of the user's requests at the domain name system (S1002)
Routing of the request to the most appropriate point of presence by the domain name system (S1003),
Determination of the desired CDN node received from the load balancer (S1004)
Questioning whether the content that should be offered to the user is available at the point of presence (S1005),
Retrieving the required content from the central device (S1006),
Sending the content to the user (S1007). Since this resource can not be dynamically given in existing CDN applications, there is an increase in the delay and the decrease in the quality of the service provided to the user in these cases.

In order to overcome the time lag that occurs in suddenly changing demand densities, some existing systems try to capture the low latency by making investments on existing hardware. However while this is a solution for situations that cause high traffic intensity, it causes resources to be idle unnecessarily at times when the number of requests is at normal level. This contradiction between obtaining a low latency period and the resource requirement puts both content providers and users in a difficult situation.

In some virtualization technologies (such as kvm, hyper-v or xen) system created for solving the mentioned above on the other hand, the load time of 12 seconds makes is difficult to respond quickly to sudden changes. However the studies conducted with the container technology allow establishment of systems that can be instrumented dynamically with a fast boot speed of 1 second. However, due to the lack of specific container management for content delivery networks, it is not possible to achieve effective resource utilization and low latency in content delivery networks.

Docker container, the container technology used in the prior art, is used in content delivery networks (CDN). The docker container is a virtualization technology that is generated by the containerization method. It offers a faster and more flexible virtualization than kvm, hyper-V technologies that are called virtual machine. With this method, network functions in the CDN (such as DNS, load balancer, edge servers) can be virtualized. In this way, functionality can be moved to the software environment by decreasing the dependency on the hardware functions of the network. But an orchestral tool is needed to manage these virtual network functions. Because it is necessary to distribute the resource usage in a balanced way by managing which network function shall work when. In this context, there is Kubernetes software developed to manage Docker containers to close the gap. However, it is not an orchestra tool that will be efficient for CDN. As it is written according to the needs of other services in the cloud computing, when a specific CPU usage is over, it alarms a Docker container needed for a new server in the cloud. In the CDN structure however, both CPU and network information should taken into account as resource usage and incoming requests should be evaluated according to request types and thereby the decision must be taken. As a result, an algorithm and a management system to do this constitute the invention in question.

As the container orchestration tools used today are not specific to content delivery networks, they are not able to reduce resource usage and latency adequately. Because existing container orchestrations (eg kubernetes) only take resources such as CPU as a criterion. However it is important to know that the real elements that reduce latency in content delivery networks are the trends and numbers of incoming requests in addition to the resource utilization. Therefore, the required low latency rate can not be achieved.

### PURPOSE OF THE INVENTION

The purpose of the invention is to create a container system specific to content delivery networks, that can substantially reduce resource utilization and latency.

Another purpose of the invention is to provide a container system that considers the tendencies and numbers of requests coming in content delivery networks.

Another purpose of the invention is to provide a container system to allow systems to be dynamically orchestrated with a fast boot-up period.

Another purpose of the invention is to provide a container system that can reduce the latency by creating network functions that can respond quickly to sudden request changes.

Another purpose of the invention is to provide delivery networks with lower latencies at lower cost.

Another purpose of the invention is to provide a container system that brings mutual benefits for both content delivery network providers and service offered to the user.

Another purpose of the invention is to reduce the number of containers in the new distribution to a minimum according to resources, demand intensities and existing container distribution.

The container system developed to achieve the aforementioned objectives is composed of the domain name system (10), point of presence (20), physical computer (30), virtual network functions (40), virtual type-1 node (41), virtual type-2 node (42), virtual type-3 node (43), load balancer (50), workload automation engine (60) and instance manager (70).

### DESCRIPTION OF FIGURES

Attached FIG. 1 is the overview depicting the routing and details of every request created by the users (k) in the system (1) through the internet to the Domain Name System (10) over the network.

FIG. 2 is the flow diagram of the functions performed by the main system.

FIG. 2 is the flow diagram of the functions performed by the module added to the main system.

FIG. 4 shows the overall appearance of the Points of Presence (20) and Domain Name System (10) servers located in various locations around the world.

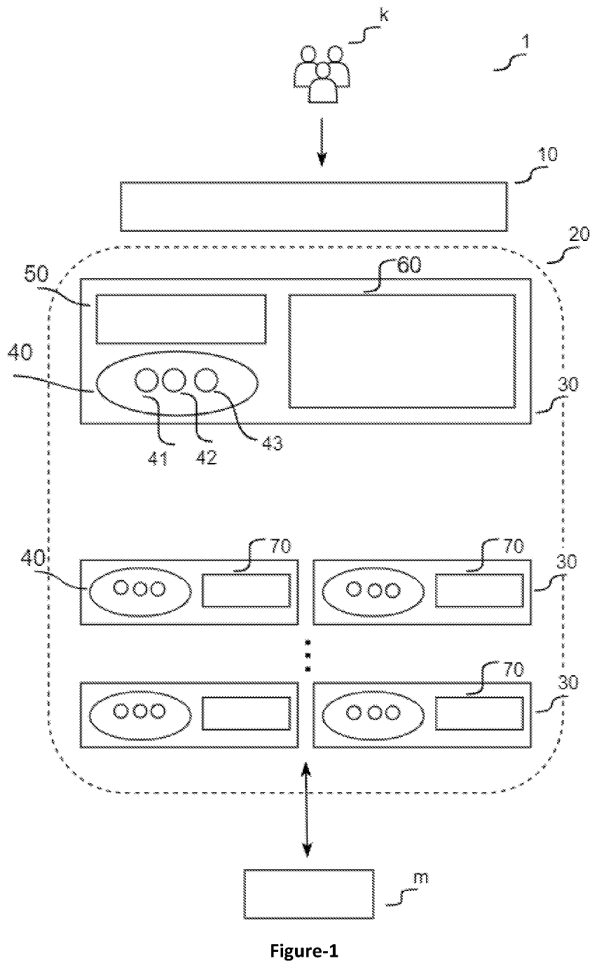

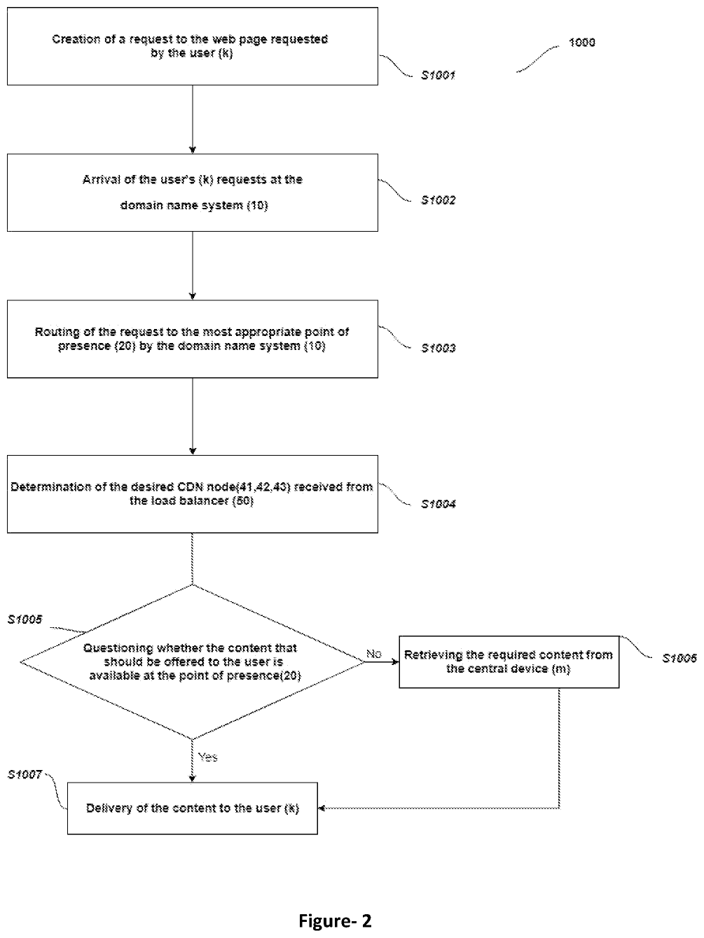

Numbers and names of main parts mentioned in the figures are given below.

(10) Domain Name System (DNS)

(20) Point of Presence (PoP)

(30) Physical Machine

(40) Virtual Network Functions (VNF) (Containment)

(41) Virtual Type-1 Node

(42) Virtual Type-2 Node

(43) Virtual Type-3 Node

(50) Load Balancer

(60) Workload Automation Engine

(70) Instance Manager

(k) User

(m) Center

### DETAILED EXPLANATION OF THE INVENTION

The invention is used by CDN (Content Delivery Network) companies to improve the quality offered to the users and to optimize resource utilization. CDN is a cloud computing service that allows users to quickly access data requested by users (large shopping sites, news sites, multimedia sharing platforms, etc.) over PoPs (Point of Presences) (20) located at various points around the world. The invention basically consists of modules and algorithms that orchestrate resource utilization by managing VNFs (Virtual Network Functions) (40) and evaluating information periodically from these VNFs (40).

CDN (content delivery networks) is briefly a cloud computing platform that hosts, optimizes digital assets including videos, images, music and code snippets and allows the end users to access the same rapidly.

The invention uses existing container technology (or: Docker containerization) in content delivery networks (CDN). And it provides the flexible system needed to respond dynamically to changing user numbers during the day by adding the orchestration algorithm customized for CDN to this virtualization system. In order to achieve this, our invention dynamically creates the network roles needed according to the user trend and when the need is over, allots them as passive for allocating resource for other network roles. It reduces the latency by creating network functions that can respond quickly to sudden request changes. Thanks to this invention, it is possible to set up content delivery networks with lower costs and with lower latencies. This brings mutual benefits for both content delivery network providers and service offered to the user.

Physical parts and operations used and carried out in this method for allowing CDN companies to improve the quality offered to the users and to optimize resource utilization are as follows: The domain name system (10) is responsible for sending requests received from the users (k) to the most appropriate content distribution site according to their location. Point of Presence (20) is referred to as the environment hosting the systems that respond to requests from the user (k). The physical machine (30) is a server having processing power and resources that can respond to incoming requests. It responds to these requests by having virtual network functions (40) within. Virtual Network Functions (40) or containerization is a name given to the container group which includes virtual network functions (40) by means of a containerizing method. The Virtual Type-1 Node (41) is the CDN node designed to meet incoming requests for small size files (e.g., pictures) in the CDN. The Virtual Type-2 Node (42) is the CDN node designed to meet incoming requests for large size files (e.g. pdf files) in the CDN. The Virtual Type-3 Node (43) is the CDN node designed to meet requests from broadcast streams (e.g. broadcast streams, live or on-demand video requests) in the CDN. The Load Balancer (50) then routes to the appropriate type of node once it knows what type of incoming request it is. If there is more than one node of the same type, it performs routing by distribution in equal amounts. The Workload Automation Engine (60) is responsible for the automatic creation or removal of the virtual CDN nodes (41, 42, 43) in the PoP (20) in which it is located. It does this with a customized algorithm. The Instance Manager (70) sends the information of the physical machine and the virtual nodes on it to the Workload Automation Engine (60).

The invention includes a workload automation engine (60) for the point of presence (20). This mechanism has five modules inside. Thanks to these modules, the new container distribution is calculated taking into account the existing container distribution, the number of requests/densities coming from in different types, and resource usage (CPU and Network). To do this, optimization algorithm is used. The aim here is to reduce the number of containers in the new distribution to a minimum according to resources, demand intensities and existing container distribution.

In the system subject to the invention every request created by the users (k) in the system (1) through the internet to the Domain Name System (10) over the network. The Domain Name System (10) selects geographically closest the Point of Presence (20). The user's request is now passed to the load balancer (50) located at the Point of Presence (20). The load balancer (50) evaluates the requests coming to the Point of Presence (20) and routes them to the corresponding node (41, 42, 43). These nodes (41, 42, 43) respond to requests from users (k). For this, they sent the file/files in the cache to the user (k). If desired file is not available in the cache at that moment, the node receives the file from the center (m) and responds to the request. Such nodes (41, 42, 43) are located in the physical machines (30) as virtual network functions (40). Each physical machine (30) has maximum one virtual network function (40) of each type. Because there is no need to have more than one virtual network function (40) that does the same job on the same physical machine (30). However, these numbers vary depending on the intensities of requests from the users (k) and the resource utilization intensities of the physical machines (30). The numbers are decided according to the algorithm running in the system (1) subject to the invention and to be explained below in detail. In this way efficient resource utilization and low latency are achieved.

Each node (41, 42, 43) uses the resources of the physical machines (30) hosting them to meet incoming user requests. In the system subject to the invention (1) is a centralized system that manages the use of this resource through the Workload Automation Engine (60). In other words, it computes according to the algorithm running on one of the physical machines (30) at the Point of Presence (20) and forming the software portion of the system subject to the invention. The WAE (60) considers the resource utilization of the physical machines at the Point of Presence (20) and the number of incoming request when computing. The module that sends the source status information of the physical machines (30) to the WAE (60) in certain periods is the Instance Manager (70). Each Instance Manager (70) sends the CPU and network information of the physical machines (30) to the WAE (60). At the same time, the WAE (60) receives the information on how many requests were received in each request type and which node (41,42,43) has responded to these requests from the Instance Managers (70) and delivers them as input data to the algorithm. In other words, the inventive system (1) is able to calculate what portion of the available resources puts some more burden on which physical machine or which node type (41,42,43) needs support for responding the requests more efficiently in order to make the new virtual node distribution (41,42,43). The algorithm of the system subject to the invention makes the calculation as follows;
As the first step, it sums up the two (CPU and network) resource utilization data after converting the resource utilization data received from the instance managers (70) into percentage. In other words, the system finds total resource utilization for each physical machine located at the Point of Presence (20). This number is maximum 200 and minimum 0 (since both sources are in percentage format).
As the second step, requests from users are grouped according to request types, and then data on how much request is received for each type of request. For example, it is informed that 2000 requests were received for the requests in image format as responded by virtual type-1 node (41), 1500 requests were received for the requests in files in large sizes (pdf, javascript/css files) as responded by virtual type-2 node (42) and 1000 requests were received for the video broadcast requests as responded by virtual type-3 node (43).
As the third step, the number of requests in each type is divided by the total number of requests. Thus, information on rational distribution of how many requests received from every request type is obtained.
As the fourth step, matrix information indicating the distribution of the virtual node (41, 42, 43) remaining from the previous period is also given to the algorithm. In other words, this matrix contains information on which physical machine is available and which is not for each virtual node (41, 42, 43). This is expressed as 1 and 0, respectively, as available and not-available.
As the fifth step, the total resource utilization information according to the physical machines obtained in the first step and the virtual node distribution (41, 42, 43) according to the physical machines obtained in the fourth step are multiplied. The result of this operation gives the distribution of load made by which node to which physical machine from the resource perspective. It is therefore desirable to determine which type of virtual node needs support.
As the sixth step, the distribution in the fifth step is translated as proportional reaping distribution as in the third step, and compared with the proportional distribution of the number of requests in the third step. The comparison range here has been set to plus/minus 0.1. If it is not within these limits, it means that the physical machine in question is under heavy load because the virtual nodes on it are exposed to high number of requests. Therefore the virtual node, which is selected to be supported less heavily in terms of resource from other physical machines, is started on the selected physical machine.
As the seventh step, this step continues until the limit values are preserved. Once the limit values are provided, the workload automation engine (60) sends the distribution of the new virtual network functions (40) to the instance managers (70).
As the eighth step, the instance managers (70) perform the opening and closing operations for each virtual node (40) operating in the physical machine (30) on which they are based, in accordance with the calculations received. And it keeps a record of the information in the first step and the second step up to the other period to send to the WAE (60).

The functions carried out by the module added to the system for allowing CDN companies to improve the quality offered to the users and to optimize resource utilization are as follows and cover following steps:
The workload automation engine (60) should be listening the instance manager (70) (S2001),
The Instance Manager (70) sends the source information of the physical machine (30) to the Workload Automation Engine (60) at the end of the period (S2002),
Number of incoming requests are sent by the load balancer (50) to the workload automation engine (60) based on the request type (S2003),
The VNF (40) distribution is created by the workload automation (60) according to the new algorithm (S2004),
Checking whether the newly generated VNF (40) distribution is different from the previous period distribution (S2005),
The new VNF (40) distribution is sent by the workload automation engine (60) to the instance managers (70) (S2006),
The processes to be performed with respect to each of the CDN nodes( 41, 42, 43) in their own physical machines (30) are compared by from the instance managers (70) according to the decision received from the workload automation engine 60 (S2007),
Observations of the requests up to the end of another period and the monitoring of the source states of the physical machines 30 (S2008). The functions performed by the module added to the main system (2000) and the process steps mentioned are also shown as a flow chart in FIG. 3.

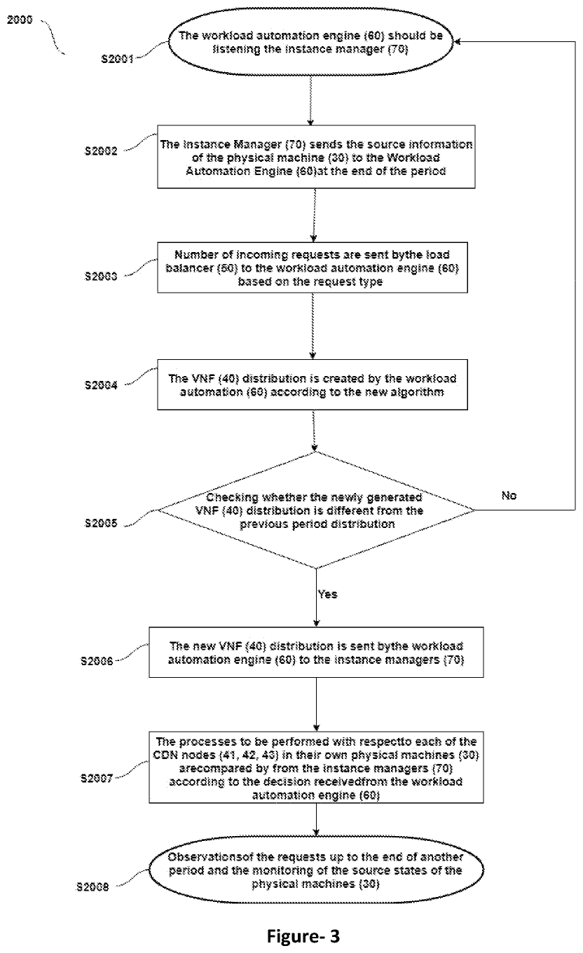

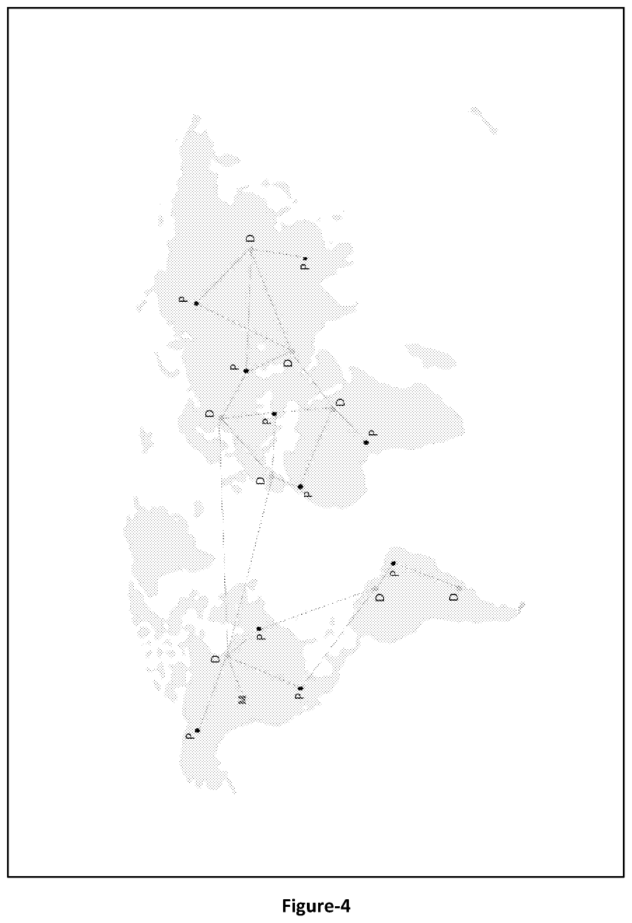

There are Points of Presence (20) and Domain Name System (10) servers located in various locations around the world in entire system. The points referred with letter “D” in FIG. 4 show DNSs (10) and the servers referred with letter “P” show the PoPs (20). Each PoP (20) point is known by at least one DNS (10) server. When a user makes a request to a page, the DNS (10) servers redirects to the nearest PoP (20) that can handle request. If the content is available in the selected PoP (20), the request is met; otherwise it goes to the central server (indicated by the letter “M” in FIG. 4). This central server is the original owner of the content.

In the system subject to the invention; no changes were made to the general data transfer. Only the automation mechanism that organizes resource usage within each PoP server (20) has been added to the system. For this purpose, the method of virtualization of network functions has been chosen and basically two separate modules have been added to the system: Workload Automation Engine (60) and Instance Managers (70). Docker Containerization is the tool used to virtualize network functions. The whole system of the invention is shown in FIG. 4

Algorithm 1 - Work Load Automation Engine Working Principle
Input: Average CPU capacity vector C, network output traffic T,
number of request distribution for each request type R^{N}, and container
distribution matrix A_{NxM}
Output: New container distribution matrix B_{NxM}

| | |
|---|---|
| 1: | Vₛᵤₘ ← C + T |
| 2: | D ← Vₛᵤₘ.A |
| 3: | D^{N} ← NORMALIZE (D) |
| 4: | while A_{NxM}is changed do |
| 5: | for i = 1 to length of D^{N} do |
| 6: | if Rᵢ^{N} − 0,1> Dᵢ^{N} then |
| 7: | j ← FINDMINLOADEDMACHINE(A_{NxM}, Vₛᵤₘ) |
| 8: | [symbol] ← 1 |
| 9: | else if Rᵢ^{N} + 0.1 < Dᵢ^{N} then |
| 10: | j ← FINDMAXLOADEDMACHINE(A_{NxM}, Vₛᵤₘ) |
| 11: | [symbol] ← 0 |
| 12: | end if |
| 13: | end for |
| 14: | D ← Vₛᵤₘ.A |
| 15: | D^{N} ← NORMALIZE (D) |
| 16: | end while |

Algorithm 1 is a customized orchestration algorithm for CDN. The algorithm creates new virtual node distributions by obtaining the CPU and network usage information from the Instance Managers (70) and the distribution matrix of the instant virtual nodes (41, 42, 43) in the physical machine at the points of presence (20).

The explanations for the symbols used in Algorithm 1 are given in Table 1. At the same time, since the algorithm is developed as a solution to an optimization problem, the corresponding optimization formula is given in Equation 1.

TABLE-1
Mathematical Symbol Explanations

| Parameter | Description |
|---|---|
| N | Number of physical machines |
| M | Number of virtual networks to be orchestrated |
| Z | Total number of containers in the instant system |
| A_{NxM} | Container distribution matrix per physical |
| | machines (algorithm input) |
| B_{NxM} | Container distribution matrix per physical |
| | machines (algorithm input) |
| R = {r₁, r₂ , r₃, r₄} | Vector of number of requests according to |
| | physical machines and request types |
| C = {c₁, c₂, . . . , c_{N}} | CPU usage data by physical machines |
| T = {t₁, t₂, . . . , t_{N}} | Network usage data by physical machines |

$$\begin{matrix}mimimize z { \sum }_{i ∈ N} {z}_{i} \\ subject to {X}_{i}^{N} - 0.1 \leq {R}_{i}^{N} , \leq {X}_{i}^{N} + 0.1 , ∀ i ∈ ℕ ( 2 ) \\ {A}_{i j} = 1 ⋁ {A}_{i j} = 0 , ∀ i , j ∈ ℕ ( 3 )\end{matrix} \qquad Equation 1$$

Numbers expressed in Equation 1; while attempting to minimize the total number of containers present in the system (process 1), it is attempted to maintain the limit value between the source distribution and the number of incoming requests (process 2). In doing so, each physical machine can have a maximum of one container of the same type (process number 3).

The process logic of the algorithm and the equation are shown with the sample values given below. The symbols C, T and R are described in Table 1. The sample system shows an example for three physical machines.

Resulting R^{N} ve X^{N} data are compared with the processing in Equation (1) (processing number 2).

These operations continue until the criteria in Equation-1 are satisfied and as a result, the output of the algorithm is generated as B_{N×M} stated in Table-1. This output is sent by the WAE (60) to all Instance Managers (70) at the Point of Presence (20). This system runs over the collected data for specific periods and generates the corresponding output.

1. A system used by CDN companies to improve quality offered to users and to optimize resource utilization comprising the following process steps:
a workload automation engine listening to an instance manager,
the instance manager sends a source of information of a physical machine to the workload automation engine at the end of a period (S2002),
number of incoming requests are sent by a load balancer to the workload automation engine based on a request type,
a VNF distribution is created by the workload automation engine according to a new algorithm,
checking whether the newly generated VNF distribution is different from a previous period distribution,
the new VNF distribution is sent by the workload automation engine to instance managers,
the processes to be performed with respect to each of CDN nodes in their own physical machines are compared with the instance managers according to a decision received from the workload automation engine, and
observing of the requests up to the end of another period and monitoring of the source states of the physical machines.

2. The system of claim 1, wherein the workload automation engine is responsible for automatic creation or removal of the virtual CDN nodes in a PoP, in which, the PoP is located and performs such operation through a customized algorithm and the instance manager sends the information of the physical machine and the virtual nodes on the PoP to the workload automation engine.

3. A new algorithm comprising:
as a first step, the algorithm sums up two (CPU and network) resource utilization data after converting the resource utilization data received from instance managers into percentage,
as a second step, the algorithm requests from users which are grouped according to request types, and then data on how much request is received for each type of request,
as a third step, the number of requests in each type is divided by the total number of requests, designating information on rational distribution of how many requests received from every request type is obtained,
as a fourth step, matrix information indicating the distribution of a virtual node remaining from a previous period is fed to the algorithm,
as a fifth step, a total resource utilization information according to physical machines obtained in the first step and the virtual node distribution according to physical machines obtained in the fourth step are multiplied and the result of this operation gives the distribution of load made by which node to which physical machine from the resource perspective and makes it possible to determine which type of virtual node needs support,
as a sixth step, the distribution in the fifth step is translated as proportional reaping distribution as in the third step, and compared with the proportional distribution of the number of requests in the third step,
as a seventh step, once the limit values are provided, a workload automation engine sends the distribution of the new virtual network functions to the instance managers, and
as an eighth step, the instance managers perform opening and closing operations for each virtual node operating in the physical machine on which they are based, in accordance with the calculations received and the algorithm keeps a record of the information in the first step and the second step up to the other period to send to a WAE.
